(19) United States
(12) Patent Application Publication
(10) Pub. No.: US 2002/0010863 A1
(43) Pub. Date: Jan. 24, 2002

(54) Method for protecting software

(76) Inventor: Stefan Mankefors, Vanersborg (SE)

Correspondence Address: TRACY W. DRUCE, KILPATRICK STOCKTON LLP, 11130 SUNRISE VALLEY DRIVE, SUITE 300, RESTON, VA, 20191-4329, US

(21) Appl. No.: 09/876,217

(22) Filed: Jun. 8, 2001

Related U.S. Application Data
(60) Provisional application No. 60/210,201, filed on Jun. 8, 2000.

(51) Int. Cl. G06F 12/14

(52) U.S. Cl. 713/189

(57) ABSTRACT

The present invention relates to a method for preventing unauthorized reproduction first data, e.g., software. A computer provides second data as Operating System instruction and data. Control data is generated using third data which is separate from the second data, and the second data is manipulated by inserting the control data within a portion of the second data when installing the first data on the computer.

### CROSS REFERENCE TO RELATED APPLICATIONS:

The present application claims priority to U.S. Provisional Application No. 60/210,201, filed Jun. 8, 2000. Said application in its entirety is hereby expressly incorporated by reference into the present application.

### BACKGROUND OF THE INVENTION

Technical Field. The present invention teaches a method and arrangement for protecting data, such as a computer program, arranged on a computer readable media from unauthorized access and duplication. More particularly, the present invention teaches a method and arrangement for preventing unauthorized reproduction of first data using second data provided as Operating System instructions.

Background Information. The software industry loses large amounts of income each day due to unauthorized copying and distribution of software, so-called software piracy. According to BSA (Business Software Alliance) more than 38% of all software in use is illegally copied, worldwide. In 1998, software piracy cost the software industry $11 billion in lost revenue. Due to loss revenue, there are fewer jobs, less innovations, and higher costs for consumers. In 1998, software piracy costs has led to $4.5 million in fines and legal fees for U.S. businesses alone. Software piracy cost 109,000 jobs in 1998 and by 2008, software piracy is expected to cost an additional 175,700 jobs (www.nopiracy.com).

Presently, there are several methods to prevent software piracy. These methods can be divided into three sections: company or organization-based protection, hardware-based protection and software-based protection. Company or organization-based protection typically includes a system operator (sysop) or a person having a similar function who handles software licensing and controls the installation of software programs. Unfortunately, this type of protection is limited to the company/organization and presumes careful management of the network and licences corresponding to the installed programs. However, this type of management is usually limited to UNIX systems and is rarely found within the PC or Macintosh-based networks. Such networks include many stand alone computers with very little insight from the sysop. In such a premise, it is primarily the internal rules (preferably with respect to copyright legislation), which police and prevent illegal and unauthorized copying of the software. Nevertheless, it is important to distinguish the legally acquired programs of the employers from the employees' private downloaded and/or copied ones. For example, employees can make unauthorized copies of an employer's software and use the unauthorized copies at home rather than purchasing the software for personal use. One factor that has contributed to this problem is easy access to CD-recording devices, which allows for mass copying of software programs.

Different types of hardware-based protection are available. Generally, hardware-based protection systems require special devices to be connected to the computer in order to run a program. This type of protection can be considered as “waterproo.” The CD-ROM player of the middle 90's was one type of hardware-based protection, which necessitated use of CD-ROMs for running certain types of programs, such as computer games, CAD programs, etc. However, this type of hardware-based protection is less effective with the introduction of low cost CD-recorders (burners). Hardware locks are also available. Hardware affects the function of the mouse and keyboard during the execution of a program. Nevertheless, this solution was doomed to fail, as it was not flexible enough.

Software-based protection is the most common protection. Software-based protection utilizes a program to control access and prevent unauthorized access. Unlike the protection types described above, software-based protection is non-invasive and does not require additional or special equipment. Furthermore, this protection cannot be removed without effort or by upgrading the storage means. The software-based protection is independent of the storage medium, administration and user. In addition, the software-based protection does not encroach on the personal integrity of the users. Software-based protection requires the use of serial numbers, locking code, code keys etc., in order to start a program or to provide limited access during a trial period. For example, without a proper code key, an installation program cannot be accessed. This solution is common and is used by, e.g. Microsoft® for Windows®, MS Office® etc.

For better understanding of the strengths and weaknesses of the presently available software-based protection, it is necessary to study the involved mechanism. The most common form software-based protection is controlling the legitimacy of the user is by prompting the user for a serial number, a code key, a colour code etc. The software compares the user's entry with an internally stored code. If the code is correct, the software can be used. To be user-friendly way and avoid unnecessary interruptions, the procedure is usually used only once.

More advanced software-based protection methods compare the code with a hardware-based serial number, e.g. a serial number of the network card, the size of hard disk or the like to control whether the installed software has been moved or not. If the program has been moved, it cannot be run. In some cases, the software communicates the serial number to the outside world if the computer is connected, e.g. to Internet. If the program finds a copy of itself registered somewhere else, the program stops running.

In many cases, however, besides the first control of the code key, no further controls are carried out. Further drawbacks include: (a) the code key and the installation program are portable and can be installed anywhere. Usually, the code key and the program can be duplicated and distributed. (b) The control over the Internet demands a connection link, preferably a permanent one, which excludes the home/home office users without (permanent) connection possibilities. It is also possible to manipulate the scripts, communication related system files or simply interrupt the Internet connection. (c) The initiation control, which searches for proof that a code key has been used, normally uses one or several indicator “flags.” It is possible to copy the flag file together with the corresponding program, which then can be distributed. In this case, it does not matter if a unique code key, e.g. the serial number of a hardware device, is used as long as the flag file is copied (and maybe manipulated) and distributed. There is no difference between the copied flag file and the original flag file. From the program's point of view, it will be considered a legitimate copy if intact flag files are found. Thus, due to the problems with the flag files, the control of the original hardware (serial number) is less important. There are also many ways to bypass the flag files or just “clone” the program and corresponding flag files and then run the program. There is no need for a “genuine” installation of the program, provided that the flag files are found, which is considered to be a simple operation, specially with all the help one can find on the Internet.

U.S. Pat. No. 5,199,066 discloses a method and system for protecting a software program recorded within a storage medium for use with or transmission to computer or processor-based hardware. The protection requires entering a hardware code uniquely associated with the particular hardware and entering a first software code uniquely associated with the particular embodiment of the software. A first predetermined operation is performed upon the hardware code and the first software code to produce an intermediate code. A unique activation code obtained from the software supplier is inputted and a second predetermined operation is performed upon the intermediate code and the activation code to produce a second intermediate code. The second intermediate code is compared to a second software code uniquely associated with the particular embodiment of the software and stored in a hidden location within the software. The use of the software is enabled only if the second intermediate code and the second software code are identical.

European Patent No. 598 587 discloses a method for locking software programs to a particular disk. The method includes the steps of creating several files, one of files has a fixed name and at least one other file having a random name; saving the head, cylinder and sector information for each of the files in the corresponding file along with use count information; saving the names of all the files in the first file with the fixed name, and encrypting all the files. This program locking method permits the distribution of trial copies of software programs and limits the risk that the program will be copied or used more than the permitted number of times.

U.S. Pat. No. 5,745,568 discloses a method for securing CD-ROM data for exclusive retrieval by a specified computer system. The method includes the steps of ordering a computer system, designating a selected hardware configuration and selected software components and procuring the selected hardware. A hardware identifier is associated with the selected hardware. The method further includes the step of producing a compact disc read-only memory (CD-ROM) containing software program files corresponding to the selected software components. This step includes the sub steps of encrypting the software program files using the hardware identifier as an encryption key and writing the encrypted software program files to the CD-ROM. The CD-ROM securing method also includes the step of installing the software programs on the selected hardware including the sub steps of retrieving the hardware identifier associated to the selected hardware, decrypting the software program files using the hardware identifier as a decryption key and installing the decrypted software program files on the hardware.

International application WO 98/43169 discloses a secure data storage system comprising a secured data file, a secured system file, and a data file application. The secured data file may have a verification system operable to allow access to the secured data file only upon receipt of a unique identifier matching a stored, unique identifier. The data file application may be operable to communicate the unique identifier to the secured data file to access the data file in a secured session. The secured system file may be linked to the data file application to establish access privileges during the secured session.

U.S. Pat. No. 5,509,070 discloses a method and apparatus for encouraging distribution, registration, and purchase of free copyable software and other digital information, which is accessed on a user's system via a programmer's program. Software tools, which can be incorporated into a programmer's program, allow the user to access advanced features of the programmer's program only in the presence of a valid password, which is unique to a particular target ID generated on an ID-target such as the user's system. Advanced features will re-lock the software if the password is copied to another ID-target. If a valid password is not present, the user is invited to obtain one. The user is provide with means for obtaining the password and installing the password in a place accessible to the user's system on subsequent occasions.

U.S. Pat. No. 4,688,169 discloses a computer software security system for restricting execution of a computer program to a particular machine, including means for storing a Machine Identification Code (MIC) in the program and means for determining the presence of the MIC in the means for storing during execution of the program. The machine identification code unique to the machine is retrieved and compared with the MIC in the program. The system prevents further execution of the program unless both codes are present and match. In one embodiment, the MIC is stored in the Operating System (OS) file of the computer.

To boot a computer is to load an operating system into the main memory or RAM (Random Access Memory) of the computer. Once the operating system is loaded, the computer is ready to run application programs. On larger computers (including mainframes), the equivalent term for “boot” is “Initial Program Load (IPL)” and for “reboot” is “re-IPL.” Boot is also used as a noun for the act of booting, as in “a system boot.” The booting of an operating system works by loading a very small program into the computer and then giving that program control so that it in turn loads the entire operating system. Booting or loading an operating system is different from installing it, which is generally an initial one-time activity. Typically, when an operating system is installed, it is set up so that when the computer is turned on, the system is automatically booted as well. Usually, the operating system is set up to boot (load into RAM) automatically in this sequence:

When a computer is turned on, the Basic Input-Output System (BIOS) of the system's read-only memory (ROM) chip is started and takes charge. BIOS is already loaded because it is built-in to the ROM chip and, unlike RAM, the contents of ROM are not erased when the computer is turned off. BIOS first does a “power-on self test” (POST) to make sure all the computer's components are operational. Then the BIOS's boot program looks for the special boot programs that will actually load the operating system onto the hard disk. First, it may look to drive A at a specific place where operating system boot files are located. If the operating system is MS-DOS, for example, it will find two files named IO.SYS and MSDOS.SYS. If there is a diskette in drive “A” but it is not a system disk, BIOS will send a message that drive A does not contain a system disk. If there is no diskette in drive A, the BIOS looks for system files at a specific place on the hard drive. Having identified the drive where boot files are located, the BIOS next looks at the first sector (a 512-byte area) and copies information from it into specific locations in RAM. This information is known as the boot record or Master Boot Record. The BIOS then loads the boot record into a specific place (hexadecimal address 7C00) in RAM. The boot record contains a program that BIOS now branches to, giving the boot record control of the computer.

The boot record loads the initial system file (for example, for DOS systems, IO.SYS) into RAM from the diskette or hard disk. The initial file (for example, IO.SYS, which includes a program called SYSINIT) then loads the rest of the operating system into RAM. (At this point, the boot record is no longer needed and can be overlaid by other data.) The initial file (for example, SYSINIT) loads a system file (for example MSDOS.SYS) that knows how to work with the BIOS. One of the first operating system files that is loaded is a system configuration file (for DOS, it is called CONFIG.SYS). Information in the configuration file provides the loading program which specific operating system files need to be loaded (for example, specific device drivers). Another special file that is loaded is one that provides which specific applications or commands the user wants to have included or performed as part of the boot process. In DOS, this file is named AUTOEXEC.BAT. In Windows, it is called WIN.INI. Once all operating system files have been loaded, the operating system is given control of the computer and performs requested initial commands and then waits for the first interactive user input.

### SUMMARY OF THE INVENTION

The present invention assist in preventing unauthorized copies of software, e.g., computer readable data. Moreover, the present invention provides an application, which is not part of the Operating System of a computer but can be installed on the computer, e.g. as a third party application, but uses the Operating System to provide security.

The present invention also provides a system for program manufacturers and retailers to achieve a simple but very efficient copy protecting system. In one embodiment, the present invention discloses a method for preventing unauthorized reproduction of computer readable data. The method includes the steps of providing an instruction set being separate from the operating system; acquiring hardware-based information using a first control; comparing the acquired information with previously stored information; when the hardware information has not changed, acquiring a hardware-based configuration; generating at least one unique location for a security resource within a portion of the Operating System, based on the hardware identity and/or hardware configuration; controlling the presence of the resource and, in case the resource is present, performing a self consistency inspection. When a positive inspection result occurs, generating a new unique location; performing a search for controlling pre-installations in this new unique location and performing a self-consistency, and in case of self-consistency, processing the data.

Preferably, the computer hardware control comprises acquiring a serial or part number of a machine part. The hardware identifier is used to initialise a random-number generator, which generates one or several random locations within the Operating System file, based on the input information. The locations are always the same as long as the initialising numbers are the same. The resource includes a flag and a correctly stored address of the flags or identity. The self-consistency inspection includes inspection of time of installation of program and/or additional random numbers. Security is achieved as the location is unique both with respect to the hardware based information and also the program installation time. In absence of a resource, it is firstly controlled whether a first resource is present, and if it does not, a first resource is installed and installation mode is initiated. If a first resource exists, it is controlled whether the method is in an installation mode and if the self-consistency exists and, if the result is negative, processing of the computer readable data is stopped. In case of operation in installation mode, an operator is asked for a code key obtained from a supplier of the data. If a correct code key is entered and is correct, control is approved and the computer-readable data is processed.

The present invention also refers to a method for purchasing and securing software in a system comprising a costumer computer, a server, a database and a key server. The method comprises: purchasing or downloading by a customer software, installing the software on the customer computer and registering the software in the database, registering the software having a unique code, using a copy protection system, which is also installed on the customer computer substantially frequently accessing the database, and communicating by using the installed software with the database for unlocking the software.

In one aspect the invention relates to an article of manufacture comprising: a computer-usable medium having a computer-readable program code and means embodied therein for preventing unauthorized reproduction of first data, the computer being provided with second data provided as Operating System instruction and data and the method comprising a step of generating control data, wherein the control data is generated by means of third data being separate from the second data, and the second data being manipulated by inserting control data within a portion of the second data when installing the first data on a computer.

According to another aspect the invention relates a computer data signal embodied in a carrier wave comprising first data, for preventing unauthorized reproduction of the first data stored on a computer, the computer being provided with second data provided as Operating System instruction and data and the method comprising a step of generating control data, wherein the control data is generated by means of third data being separate from the second data, and the second data is manipulated by inserting the control data within a portion of the second data when installing the first data on the computer.

According to yet another aspect, in a computer provided with an operative system, the invention relates to a computer program product for use with an executable computer program, the computer program product comprising: an instruction set for preventing unauthorized reproduction of first data, the computer being provided with second data provided as Operating System instruction and data and the method comprising a step of generating control data, wherein the control data is generated by means of third data being separate from the second data, and the second data is manipulated by inserting the control data within a portion of the second data when installing the first data on the computer.

The invention also relates to a system for managing a security code distribution for preventing unauthorized reproduction of first data, the system being established as a partnership, each partner being one of a plurality of users of the first data, or distributors and/or developers of the same, comprising a computer processor means for processing data; storage means for storing data on a storage medium; first means for initialising the storage medium; second means for generating an instruction set to be delivered to at least one of the distributors and/or developers for integration with the first data, the instruction set being provided for generating control data for preventing unauthorized reproduction of the first data; third means for storing the instruction set on the storage medium, and fourth means for making the instruction set on the storage medium available for distribution to one of the distributors and/or developers on demand.

The instruction set is a compiled program code and the instruction set integrated with the first data on a computer is modified with respect to hardware information and requiring a first code key from the system in return for an identity code. The identity code comprises one or several of hardware identity, installation-based information or a unique identifier. The system provides a key of a first type when installing first data, which allows installation of the program. The system provides the developer/distributor with a key of second type, which allows producing and/or distributing keys of first type specific for the instruction set of the developer/distributor.

The invention also relates to a computer unit comprising memory unit, input/output units and a mass storage unit, on which an operating system file is provided for controlling functions of the computer unit, and programs for running application on the computer unit. It further comprises a set of instruction codes for preventing unauthorized reproduction of at least one of the programs running an application on the computer unit, through generating control data, and storing the control data within a portion of the second data being part of the operating system of the computer, when installing the first data on the computer.

### BRIEF DESCRIPTION OF THE DRAWINGS

In the following, the invention will be further described in a non-limiting way with reference to the accompanying drawings in which:

FIG. 1 illustrates a block diagram of a system according to one embodiment of the present invention;

FIGS. 2 and 3 illustrate a flowchart showing the steps of a method according to one embodiment of the present invention;

FIG. 4 illustrates a block diagram of a section of a security distribution mechanism according to one embodiment of the present invention; and

FIG. 5 illustrates a block diagram of a section of a security distribution mechanism, according to another embodiment of the present invention.

### DETAILED DESCRIPTION OF PREFERRED EMBODIMENTS

The present invention provides protection against unauthorized copying of software by tying a software license to a computer on which the software is intended to run and not to the user/buyer. Thus, the present invention uses a controlling mechanism for controlling the hardware identity or related information of the computer or unique information based on hardware identity, such as an internal card, processor or other component identity, hard disk size, installation time or date, number of files on the hard disk and/or mouse pointer position etc., for verifying that the software runs on the correct computer; unique protection for each software license sold, e.g., each installed software has a unique way of protection identification dedicated to it, preventing distribution of information about “hacking” and unauthorized accessing methods; and generating invisible and/or copy protected information on each individual computer.

Presently, a common approach in bank transactions using information technology is to use non-recurrent codes, i.e., codes that can be used only once for a transaction, a connection or the like, thus, providing a very secure and non-forcible code. Similarly, using non-recurrent codes during a software installation process is effective. However, using non-recurrent codes is not always practical. For example, using a recurrent code for a word-processing program is not very user-friendly and can intimidate the user. In the following, the term “non-recurrent” relates to a unique code that can be obtained only once. Consequently, the non-recurrent codes will guarantee that the user can install the software only once. A unique non-recurrent code key can be included in the software package when it is purchased or downloaded from a site on the Internet, BB, etc. For several installation, several unique non-recurrent code keys can be used, e.g., a license for a limited number of users. In some scenarios, a code key may not be included in the program installation and must be obtained separately.

Combining the use of a non-recurrent code key with hardware (identity) control provides protection against unauthorized copying of software. During the installation of the program, the user can be provided with specific information to complete a non-recurrent code and not until after that will the user be provided with the code key. Thereby, it is possible to guarantee that the code key cannot be used for installation of the software on another computer. The hardware information may comprise a serial or identity number of a network card, a graphic card, an installation location of the operative system or other system-related programs, an assigned IP number of the specific computer etc., or a combination of the above. Preferably, the identity numbers are encrypted for further security.

Implementation of this solution has been unsuccessful and bulky, as the problems relating to the encryption of the information or flag file(s) have remained unsolved. According to the present invention, this problem is solved by using a new approach, which involves protection of the “verification flags” themselves.

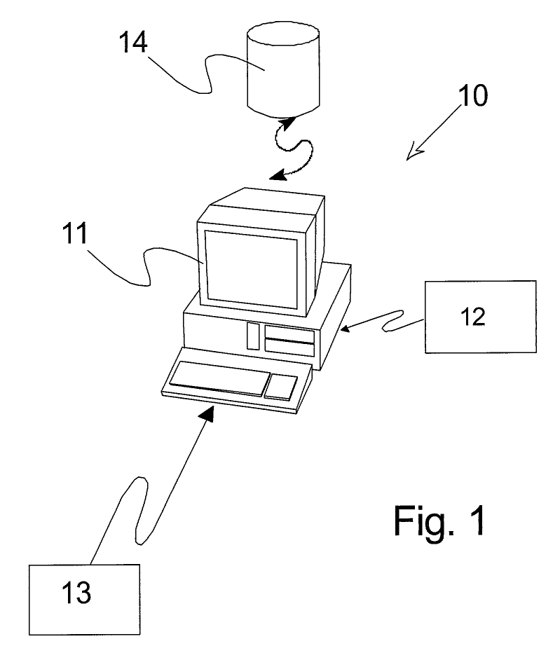

Referring to FIG. 1, a block diagram of a system according to one embodiment of the present invention is illustrated. The system 10 comprises a computer unit 11, such as a personal computer. Means 12 are used for obtaining hardware-based information from one or several parts of the computer unit 11. The system 10 further includes means for accessing a unique code key from a software supplier based on the hardware information together with a non-recurrent key 13 obtained from the user. For example, the installed software becomes tied to the hardware at installation time, preferably the time when the program is first executed is used in the code generation. The system 10 further includes a verification routine, which makes it possible to save control information (flags) in a special location 14, accessible by the computer unit 11. Thus, the storage and verification of the flags, which certifies the authorised use of the program. In the following, the term “flag” is used for all types of data that are stored on the computer and used as verification information.

In current applications, flags are saved in a file which can be a part of the program itself or placed at another location on the hard disk or a storage arrangement, which is “difficult” to find. The present invention stores flags (control information or an identification code) within the only continuous program in a computer, e.g., the Operating System file(s). Therefore, instead of generating and storing one or several flags in special files, the flags are inserted inside one or several existing Operating System files, by manipulating the existing system files. Thus, the flags are installed in an application which is not part of the existing Operating System, but as a program installed on the computer.

Since the size of modern system files and innumerable additions, finding flags of related information is very difficult. In the Macintosh” operative system, MacOS, for example, there are approximately 10¹² addressing possibilities within a system file. The same is true for Windows®. In addition, it is also possible to change the address, position or the appearance of flags in relation to hardware-based information. However, storing the flags in the system file is advantageous due to the smaller size of the system file. For example, finding information consisting of, e.g. 10 bytes within a 10 MB file is much more difficult than finding a file within for example ten thousand files. Moreover, changes, additions, modifications and manipulations of the system file involve great risks, which can end in a system failure or affect the correct function of the computer etc., which is not the case if a non-system file is manipulated. Also, a search for the flags in the system file will probably result in malfunction of the computer.

In addition, the solution based on the hardware specific flags makes it difficult, if not impossible, to clone the entire system. It is not enough to copy and distribute the flags rather, they must be correct flags, which means that the system file of the computer running the copied program must also be copied or manipulated. A copied system file cannot be installed on other computers and a manipulated system file will certainly affect the computer operation.

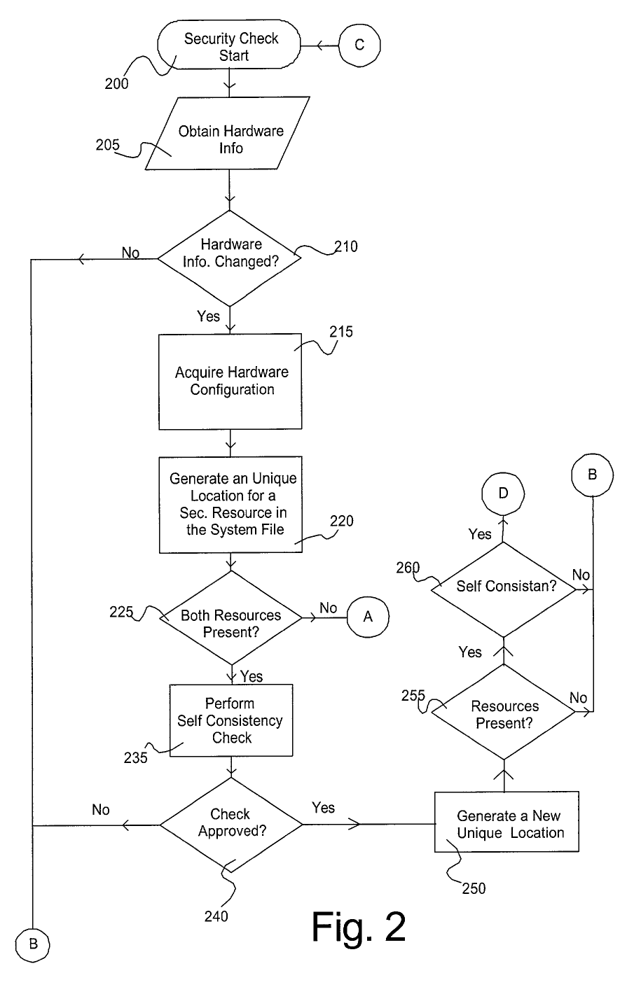

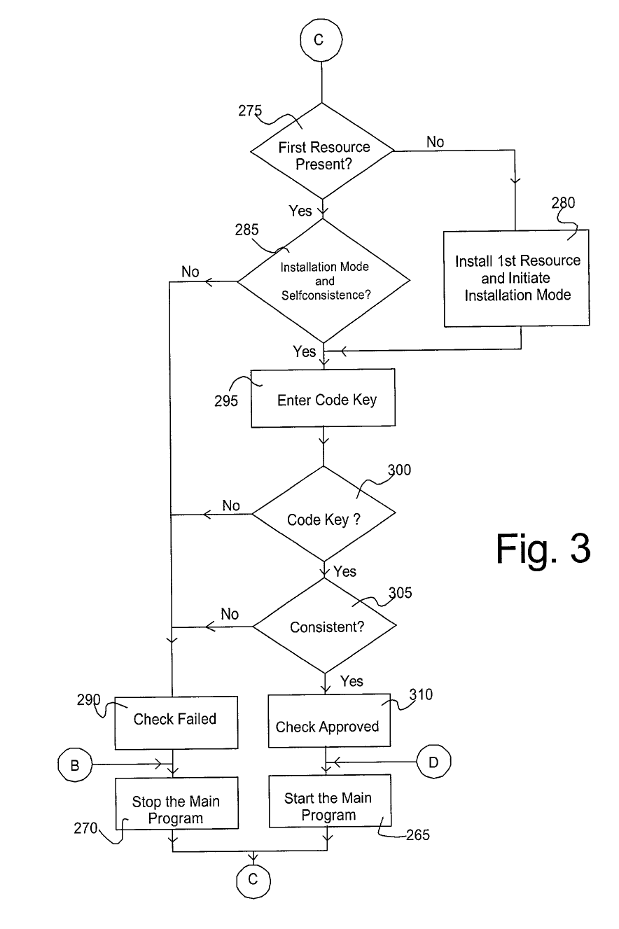

Referring to FIGS. 2 and 3, a verification procedure in accordance with one embodiment of the present invention is illustrated. The procedure starts with a control 200. The only input to the security routine can be a single Boolean variable. If this is given the value ‘true’, the security is accepted, if not the security has failed or there is a malfunction, then the main program shuts down. Then a hardware check is performed 205, e.g. by acquiring a serial or part number of a network card or the like. Following the control 210, if the hardware information is not changed, hardware based configuration is acquired, 215. One or more unique locations are then generated, 220, for security resources (flags) within an Operating System file, based on the hardware identity and hardware configuration. The hardware identifier is used to initialise a random-number generator. The generator in turn generates one or several random locations within the system file, based on the input information, e.g. as the random generator seed. These locations are always the same as long as the initialising numbers are the same.

Then a check is made 235 to determine whether both resources exist or not, i.e. the flags and the stored correct address of the flags or identity. If both resources exist, a self-consistency inspection is performed 225, which can include time of installation of program and additional random numbers. If the result of the inspection is positive 240, a new unique location can be generated 250 based on, for example the time of installation. Note that this location can be unique not only with respect to the machine, but also, e.g. the installation time. Then a search is carried out 255 for controlling pre-installations in this new unique location and whether it is self-consistent 260. If it is self-consistent, the program can be executed 265 (FIG. 3).

If the results of steps 210, 240, 255 and 260 are negative, the execution of the program is stopped, 270 (FIG. 3). In step 225, if both resources do not exist, the presence of the first resource is checked 275. If it does not exist, a first resource is installed and installation mode is initiated 280. However, if the first resource exists, it is determined 285 whether it is the installation mode and self-consistency, which is correct. If the result is negative, the check fails 290 and the program is stopped 270. If the second resource exists but not the first one, it is assumed that the preferences are changed and the program will not run. Nevertheless, if it is the installation mode, the user is asked 295 for a code key obtained from the supplier. If the code key is entered and is consistent 300, 305, control is approved 310 and the program is allowed to execute 265. The installation mode is executed only once.

To avoid over-writing information in the system files, the above procedure may carry out a control that the generated addresses of the system file are not occupied, and if so, new addresses are generated and controlled. In MacOS, for example, a call to a system command, such as, AddResource ( ) is used to insert the flags. Since adding data to system files is a normal procedure for many programs during installation and execution, the modifying system files is not a concern, e.g. for programmes checking for virus. These types of programs have options for controlling the size or date of the files and normally indicate such changes.

The present invention does not prevent uninstallation or reinstallation of the protected software. It is possible to uninstall the flags and thereby obtain a new code key, for example when moving the software to a new computer. For example, when installing the software on a new computer, the hardware specific information is obtained. When uninstalling the software from the old computer, the flags are deleted, thus a new non-recurrent code is generated in the old computer and entered by the user into the new computer, whereby a new code key for the new computer is generated,. It is also possible (but not necessary) to install “uninstall flags” on the old computer. Since the flags are deleted in the old computer, it is not possible to run the program on the old computer and consequently no unauthorized copying is done.

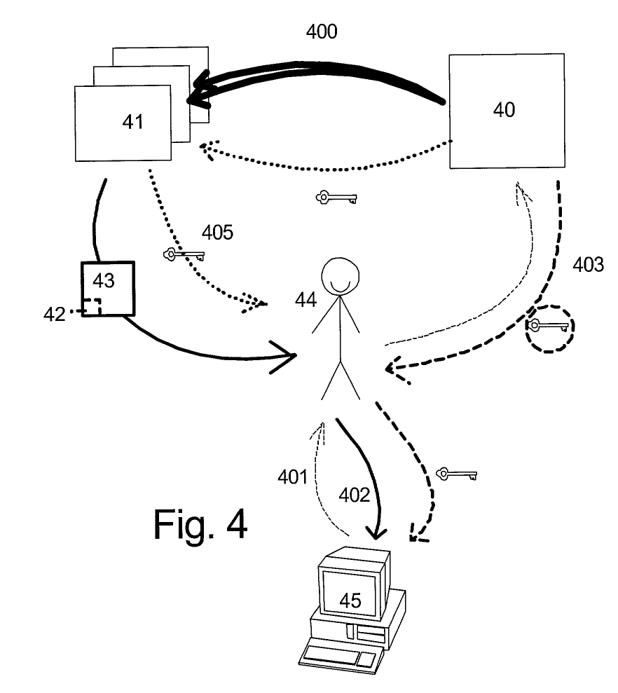

Referring to FIG. 4, a block diagram of a section of a security distribution mechanism for code keys according one embodiment of the present invention is illustrated. A Copy Protection Deliverer (CPD) 40 can establish a “code key cente.” Among others, the CPD operation consists of delivering 400 a “lock cylinder,” which includes a compiled program code to the software suppliers 41. The “cylinder” 42 is a mechanism, e.g., a security shell to be attached to or integrated with the software (package) 43 to be sold. The “cylinder” can be integrated into all programs or selected ones and have different security levels. When a user 44 installs software provided with a cylinder on a computer 45, the “cylinder” is modified with respect to the hardware information and the user is asked 401, 402 for a first key from CPD, in return for a series number or the like and hardware, installation-based information etc. The CPD provides 403 a key, e.g. using a server that produces a key of a first type and returns it to the user, which allows installation of the program.

Additionally, the CPD can provide 404 the software manufacturer/distributor with a key of a second type, which allows producing and distributing 405 keys of the first type specific for the manufacturer's/distributor's “cylinder.” CPD has a general key, which allows producing keys of the first and second type (or other types) based on this key and prevents redoubling of keys (of the second type), i.e. a Key Generating Key, based on or with the help of which, all other keys are generated. Through this procedure a track record can be generated that keeps track of the number of distributed cylinders and/or keys.

When the user wants to upgrade his computer or move the program to another computer, the program (including the cylinder) is uninstalled. Upon uninstallation, the software may produce a new installation code key or the user is asked for a correct code key to remove/move the program. The code key may be obtained directly from the supplier or a number of code keys can be obtained when purchasing the program. This operation removes the key of first type and a new one is generated when the program is reinstalled. It is not possible to have two functional copies and one key.

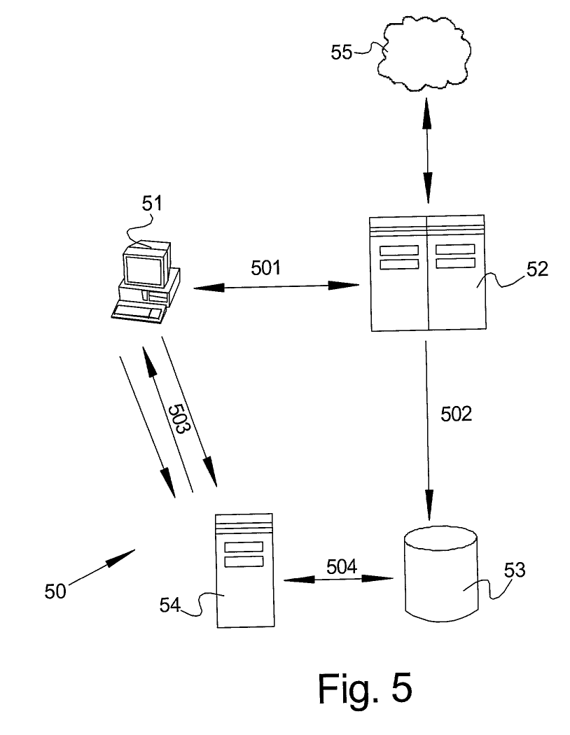

Referring to FIG. 5, an exemplary system for purchasing and securing software according to one embodiment of the present invention is illustrated. The system 50 comprises a costumer computer 51, a server 52, a database 53 and a key server 54. According to this example, a customer downloads software from a download site or buys it in a local store. The customer installs this software on a computer 51 and registers 501 the software on a site 52 or within an installation program. In a database 53 the software (which has a unique code) is registered 502. It is possible to conduct a credit check (55) or the seller of the product already has issued a license key. The Copy Protection System, CPS, which is also installed on the customer's computer 51 frequently ‘polls’ 504 the database. The installed software communicates 503 with the database so that it can be unlocked.

The above-mentioned communication is performed in 3 steps. In first step, the database is polled to determine if it is ok to unlock the software. In the next step, the database sends an OK to unlock the software. In the last step, the CPS sends 504 an OK_UNLOCKED back to the database.

Clearly, the teachings of the present invention can be applied to other types of data than executable program data, such as music, film, textual data, books, newspapers etc.

The invention is not limited the described embodiments. It can be varied in a number of ways without departing from the scope of the appended claims and the arrangement and the method can be implemented in various ways depending on application, functional units, needs and requirements etc.

What we claim is:

1. A method for preventing unauthorized reproduction of first data on a computer having second data provided as Operating System instruction and data, the method comprises the steps of:
generating control data wherein said control data is generated by means of third data which is separate from said second data;
manipulating said second data by inserting said control data within a portion of said second data when installing said first data onto the computer.

2. The method of claim 1 wherein said control data is generated using computer hardware information.

3. The method of claim 1 wherein said control data is generated using data received from a provider of said first data.

4. The method of claim 3 wherein said data received from the provider is non-recurrent.

5. The method of claim 2 wherein said computer hardware information comprises one or more of a component identity, program execution time, program installation time, number of files on a hard disk of said computer, size of hard disk and/or pointer device position.

6. The method according to claim 1, comprising a control sequence further comprising the steps of generating control data and comparing control data to said data stored within said portion of said second data being part of said operating system.

7. A method of preventing unauthorized reproduction of data on a computer having an Operating System, said method comprising the steps of:
providing an instruction set being separate from said operating system;
acquiring hardware-based information using a first control which includes a computer hardware control;
comparing said acquired information with previously stored information;
when said comparison indicates that the hardware information is not changed, acquiring a hardware-based configuration;
generating at least one unique location for a security resource within a portion of said Operating System, based on a hardware identity and/or hardware configuration;
controlling the presence of said resource and, in case the resource is present, performing a self consistency inspection;
in case of a positive inspection result, generating a new unique location;
performing a search for controlling pre-installations in this new unique location and performing a self-consistency; and
in case of self-consistency, processing said data.

8. The method according to claim 7 wherein said computer hardware control comprises acquiring a serial or part number of a machine part.

9. The method according to claim 7 wherein said hardware identifier is used to initialise a random-number generator, which generates one or several random locations within said Operating System file, based on the input information.

10. The method according to claim 9 wherein said locations are always the same as long as the initialising numbers are the same.

11. The method according to claim 7 wherein said resource includes a flag and a correctly stored address of the flags or identity.

12. The method according to claim 7 wherein said self-consistency inspection includes inspection of time of installation of program and/or additional random numbers.

13. The method according to claim 7 wherein the location is unique both with respect to the hardware based information and also the program installation time.

14. The method according to claim 7 wherein in absence of a resource, determining the presence of a first resource and installing the first resource if the determination indicates the absence of the first resource.

15. The method according to claim 7 wherein if a first resource is present, determining if the method is in an installation mode and if the self consistency exists, if the determination determines a negative, stopping the processing of said data.

16. The method according to claim 7 wherein in case of operation in installation mode, prompting an operator for a code key obtained from a supplier of said set of data.

17. The method according to claim 16 wherein if a correct code key is entered and is consistent, the control is approved and said data is processed.

18. A method for purchasing and securing software in a system comprising a customer computer, a server, a database and a key server, the method comprising the steps of:
purchasing or downloading software by a customer;
installing said software on said customer computer and registering said software;
registering said software having a unique code in said database, using a copy protection system on said customer computer; and
communicating using said installed software with the database for unlocking said software.

19. An article of manufacture comprising: a computer-usable medium having a computer-readable program code and means embodied therein for preventing unauthorized reproduction of first data on a computer having second data provided as Operating System instruction and data and a method for generating control data, wherein said control data is generated by means of third data being separate from said second data, and said second data being manipulated by inserting said control data within a portion of said second data when installing said first data on said computer.

20. A computer data signal embodied in a carrier wave comprising first data, for preventing unauthorized reproduction of first data on a computer having second data provided as Operating System instruction and data and a method for generating control data, wherein said control data is generated by means of third data being separate from said second data, and said second data is manipulated by inserting said control data within a portion of said second data when installing said first data on said computer.

21. In a computer provided with an operative system, a computer program product for use with an executable computer program, said computer program product comprising: an instruction set for preventing unauthorized reproduction of first data, said computer being provided with second data provided as Operating System instruction and data and the method comprising a step of generating control data, wherein said control data is generated by means of third data being separate from said second data, and said second data is manipulated by inserting said control data within a portion of said second data when installing said first data.

22. A system for managing a security code distribution for preventing unauthorized reproduction of first data, the system being established as a partnership, each partner being one of a plurality of users of said first data, or distributors and/or developers of the same, comprising:
a computer processor means for processing first data;
storage means for storing first data on a storage medium;
first means for initialising the storage medium;
second means for generating an instruction set to be delivered to at least one of said distributors and/or developers for integration with said first data, said instruction set being provided for generating control data for preventing unauthorized reproduction of said first data;
third means for storing said instruction set on said storage medium; and
fourth means for making said instruction set on said storage medium available for distribution to one of said distributors and/or developers on demand.

23. The system according to claim 21 wherein said instruction set is a compiled program code.

24. The system according to claim 21 wherein said instruction set integrated with said first data on a computer is modified with respect to hardware information and requiring a first code key from said system in return for an identity code.

25. The system according to claim 23 wherein said identity code comprises one or more of hardware identity, installation-based information or a unique identifier.

26. The system according to claim 21 wherein it provides a key of a first type when installing a first set of data, which allows installation of the program.

27. The system according to claim 21 wherein it provides said developer/distributor with a key of second type, which allows producing and/or distributing keys of first type specific for the instruction set of the developer/distributor.

28. A computer unit comprising memory unit, input/output units and a mass storage unit, on which an operating system file is provided for controlling functions of said computer unit, and programs for running application on said computer unit, wherein it further comprises a set of instruction codes for preventing unauthorized reproduction of at least one of said programs running application on said computer unit, through generating control data, and storing said control data within a portion of second data being part of said operating system of said computer, when installing said applications.
